(19) United States
(12) Patent Application Publication
(10) Pub. No.: US 2007/0285048 A1
(43) Pub. Date: Dec. 13, 2007

(54) Fuel cell charger interface with multiple voltage outputs for portable devices

(76) Inventors: David H. Leach, Albany, NY (US); Russel Marvin, Goshen, CT (US); Peter S. Opela, Lake Worth, FL (US)

Correspondence Address: CESARI AND MCKENNA, LLP, 88 BLACK FALCON AVENUE, BOSTON, MA, 02210, US

(21) Appl. No.: 11/451,293

(22) Filed: Jun. 12, 2006

(51) Int. Cl. H02J 7/00; H01M 10/46; H01M 16/00

(52) U.S. Cl. 320/101; 320/107; 429/7

(57) ABSTRACT

A fuel cell-based powerpack for use with an electronic device that requires multiple voltages is provided. The power pack includes an interface between a direct oxidation fuel cell and one or more rechargeable batteries coupled to supply power to the electronic application device. The interface is connected to receive the output of the fuel cell and includes one or more DC-DC converters that not only boost power to said one or more batteries, but are further coupled to the electronic device such that the fuel cell can be used to directly provide one or more subvoltages, at required voltage rails, directly to said electronic device. The output voltage can also be linearly regulated if needed in a particular application.

### BACKGROUND OF THE INVENTION

1. Field of the Invention

This invention relates generally to power packs for electronic devices and more particularly, to systems for providing a fuel cell/battery hybrid power pack for an electronic device.

2. Background Information

There are many electronic devices in widespread use today including wireless phones, laptop computers, personal digital assistants (PDAs), walkie talkie's, mobile video systems and GPS navigation systems. These devices typically operate using a battery that is recharged when the device is not in use. A fuel cell can be coupled with the battery to provide a hybrid power pack for powering the electronic device.

Many electronic devices require several voltage rails that are different than the battery output voltage. For example, in a wireless telephone, a 2.8 volt (v) voltage rail may be required for analog functionality and for the microphone and speakers of the phone. A 1.2 v voltage rail may be required for the logic within the phone, while a 1.2 to 1.6 volt rail may be required for the digital signal processing (DSP) chip. The DSP requirements will vary depending on the speed at which the DSP is being operated. Conventionally, each separate voltage is provided by either a linear regulator or a DC-DC converter that converts the battery voltage to the desired voltage level as needed by the application device for that particular function.

In other instances, a fuel cell/battery hybrid power pack is used. In that case, some or all of the voltage rails can be provided by switching regulators powered by the fuel cell. Typically, the fuel cell power is boosted or bucked by a DC-DC converter to the battery or main power rail level. Then, from the battery, it is further converted down to the respective input voltage required by the application device for the particular function.

For example, the fuel cell may provide an output voltage of 0.5 volts, and this is boosted to a Lithium battery requirement, which may be between 3 and 4.2 volts. Then, the battery or main power rail is either linearly regulated or boost/bucked further to the actual required voltage, such as the 2.8 voltage rail discussed with respect to the wireless phone. Using the conventional method there is a minimum of at least two efficiency losses. The first efficiency loss occurs during the fuel cell stage when the fuel cell power is boosted to the battery requirements. The second efficiency loss occurs when the output of the battery is regulated or converted to the application device voltage requirement. A third efficiency loss is in the battery itself since it always takes more energy to charge a battery than is generated upon discharge. The efficiency loss from the battery to the internal power rail can sometimes be greater in magnitude than the efficiency loss occurring in the initial fuel cell conversion stage. Likewise, the efficiency loss from the fuel cell to the battery can even be more than the efficiency loss going from the fuel cell directly to the internal power rail.

There remains a need, therefore, for a more efficient technique for providing multiple voltage rails for an electronic device using a hybrid fuel cell/battery power supply.

### SUMMARY OF THE INVENTION

These and other disadvantages of prior techniques are overcome by the present invention, which provides a power pack that includes a fuel cell charger interface with multiple voltage outputs for portable devices. More specifically, the electrical power at the required multiple levels is provided directly from the fuel cell using a unique interface, which is coupled between the fuel cell and the device being powered by the powerpack. The interface includes one or more DC-DC converters that each convert the fuel cell voltage to a desired level for the respective rail in the application device. The interface includes multiple voltage outputs for one or more such rails in the application device, and the application device simply draws the power as needed from each individual rail, or a programmable controller is used to switch between voltage levels as needed.

The interface bypasses the conversion step from the battery voltage to the respective subvoltages that was required in prior techniques. This realizes an efficiency not only in bypassing the second conversion step, but further the expected conversion efficiency from the fuel cell voltage via the interface is likely more efficient when converting to a final voltage which is nearer the initial fuel cell voltage, rather than first converting to an intermediate voltage with a large difference from the initial fuel cell voltage and then converting back to the final voltage.

In the invent that the power requirement of the application device exceeds the output ability of the fuel cell and interface (boost/buck switcher) an auxiliary switch or linear regulator connected to a battery can be used to supplement the fuel cell/interface power, without interruption of supply. According to one embodiment of the invention, only if additional power is needed will the auxiliary supply activate from the battery. The auxiliary supply from the battery will only source enough supplemental power to make up the difference between the full rated output power of the fuel cell interface combination and that which has been demanded by the load. This way, a secondary loss is either eliminated or lessened by the less frequent use of the auxiliary supply from the battery.

It is noted that the auxiliary supply is still needed on start up and during peak power draw. However, during on-going operations, the techniques of the present invention will provide a more efficient power supply when multiple voltages are required by the application device. This translates to a longer runtime for a given amount of fuel for the fuel cell.

In accordance with a further aspect of the invention, when a particularly noise free power supply voltage signal is required or is desirable, the fuel cell voltage is converted to a rail voltage that is just above the amount which is required. Then, it is linearly regulated back down to the desired lower voltage or set of voltages. In this case, the interface includes a linear regulator that is coupled to the output of the converter from the fuel cell. Using the linear regulator in the interface, the noise on the signal is removed by the regulator.

The interface of the present invention can include an individual switching converter which could be boost, buck, or buckboost, or any combination of individual switching converters, connected to the fuel cell system to generate the individual voltage rails. Alternatively, to reduce the number of individual switching converters that are required in the interface, a single switching converter can be used in the interface, the output of which is connected to both the application device's internal rail(s) and to the battery through output switches. Only one output switch is on at a time and the fraction of time each is on is adjusted so that each voltage is at it's desired level. Accordingly, it is possible to generate the various voltages required while reducing the number of additional converters, and inductors, in the interface.

Depending on the operating circumstances, the power output can be apportioned between the fuel cell/interface combination and the auxiliary battery power supply if it is determined that overall system efficiency is improved by such apportionment.

In accordance with a further aspect of the invention, the fuel cell and interface can maintain a pre-charge on the output side of the auxiliary battery converters, which may facilitate a fast powering of the auxiliary converter.

### BRIEF DESCRIPTION OF THE DRAWINGS

The above and further advantages of the present invention may be better understood by referring to the following description in conjunction with the accompanying drawings, in which like reference numerals indicate identical or functionally similar elements:

FIG. 1 is a schematic block diagram of a fuel cell and interface combination providing one of the subvoltages directly to a load in accordance with an illustrative embodiment of the present invention;

FIG. 2 is a schematic block diagram of a fuel cell and interface combination which incorporates a linear regulator for providing low noise power to a load in accordance with an illustrative embodiment of the present invention;

FIG. 3 is a schematic block diagram of an interface between a fuel cell system and an electronic device in accordance with an illustrative embodiment of the present invention;

FIG. 4 is a schematic block diagram of an interface between a fuel cell system and an electronic device in accordance with an illustrative embodiment of the present invention which incorporates a multiple-output DC-DC converter; and

FIG. 5 is a flow chart of a procedure in accordance with an illustrative embodiment of the present invention.

### DETAILED DESCRIPTION OF AN ILLUSTRATIVE EMBODIMENT

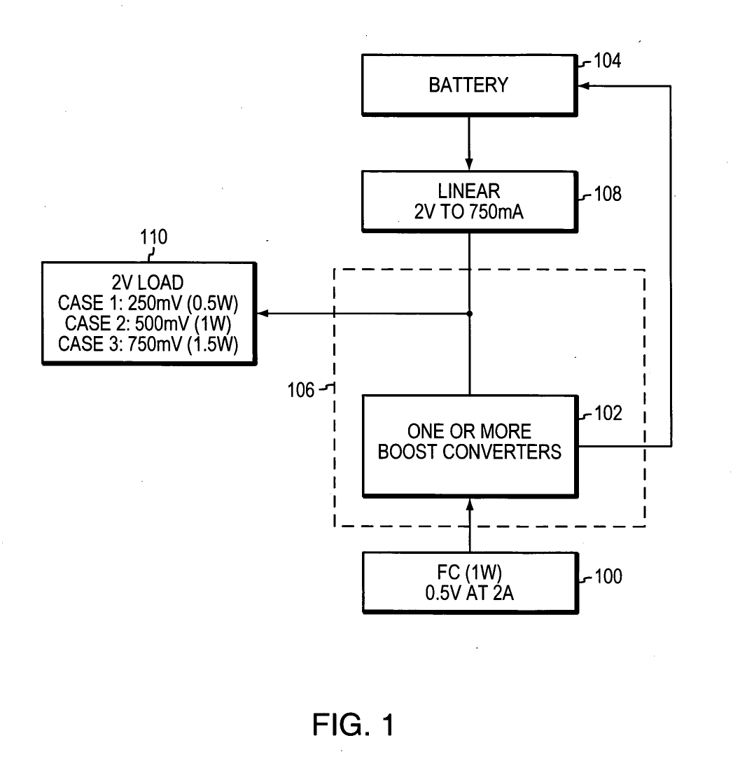

FIG. 1 illustrates a schematic block diagram of fuel cell interface combination in accordance with an illustrative embodiment of the present invention. More specifically, a fuel cell 100 may be any suitable fuel cell such as that described in commonly owned U.S. Pat. No. 6,981,877 of Ren et al., which issued on Jan. 3, 2006, which is presently incorporated herein by reference in its entirety. The fuel cell is coupled to a boost converter 102, which may be any suitable DC-DC converter readily available to those skilled in the art, or may be a DC-DC converter in accordance with commonly owned U.S. patent application Ser. No. 11/353,755 for a FUEL CELL BASED RECHARGEABLE POWER PACK SYSTEM AND ASSOCIATED METHODS FOR CONTROLLING SAME, of Leach et al., which was filed on Feb. 14, 2006, which is presently incorporated herein by reference in its entirety. The boost converter 102 forms part of an interface 106, which provides power directly to a load 110 in accordance with the invention.

Notably, in prior techniques, the converter 102 would boost the fuel cell output voltage to that required by the battery 104. It is possible that the fuel cell would be at a similar or higher voltage than the battery in which case the converter would be a buck/boost or buck type converter as appropriate. The battery 104 would have then bucked the output voltage back down to the voltage required by the particular application device being powered by the system. However, in accordance with the present invention, the interface 106 directly supplies the load. In the illustrative example, the boost converter 102 boosts the fuel cell output voltage from 0.5 volts to the required voltage which in the example is 2.0 volts, as required by the load 110.

By way of example, the fuel cell 100 may provide its power to the 2V load 110 at 0.5 watts. In that instance, the fuel cell output power is greater than the load demands, so the fuel cell 100 also supplies the additional 0.5 watts to recharge the battery 104. A voltage regulator 108 is coupled to the battery output 104, and this voltage regulator may be either a linear regulator, as shown, or may be a converter, whichever is functionally more appropriate in the particular application of the invention. The linear regulator 108 is configured to provide a voltage slightly lower than converter 102 so that when converter 102 can supply all of the power to the load, the regulator 108 does not pass current and therefore does not give rise to performance losses.

In accordance with another aspect of the invention, the fuel cell can provide 100% of its output power to the 2V load 110 at 1 watt of power as demanded by the load in that instance. Thus, the fuel cell does not additionally supply the battery. It is noted that the linear regulator 108 provides no power and does not create any losses in the system.

By way of further example, the fuel cell 100 may provide 100% of its power to the 2V load 110 at 1 watt but the load requires 1.50 watts, which is more than the fuel cell capacity. Thus, the battery 104 (through the linear regulator 108) supplies the additional 0.5 W to the load at 2 volts.

As is apparent from these examples, it is preferred that the battery 104 delivers supplemental power to make up the difference, if any, between the output power of the fuel cell/interface 106 combination, and that which is demanded by the load 110. Other situations may arise in which the demands of the load are such that it is better to apportion the power needs between the battery 104 and the fuel cell interface combination in a different manner, and the invention is readily adaptable to such an apportionment.

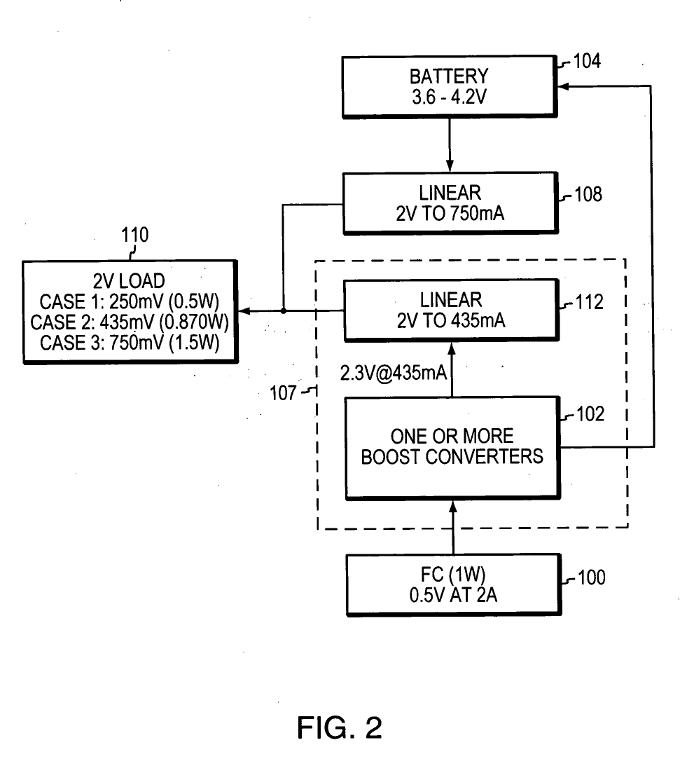

FIG. 2 illustrates a schematic block diagram of another embodiment of the present invention which the interface includes a linear regulator for loads that require less ripple noise than is provided by a switching regulator. In the embodiment of FIG. 2, the fuel cell 100 is coupled to the interface 107, which includes a boost converter 102 and a low drop out linear regulator (LDO regulator) 112. In accordance with the present invention, the fuel cell 100/interface 107 combination supplies the required rail voltage of 2.0 volts directly to the load 110 for a case in which a more regulated voltage is required. For example, if the desired rail voltage for the load is, for example, 2.1 volts, but the output of the converter 102 is a noisy signal that is varying between 2.15 volts and 2.45 volts, then the interface 107 passes this varying voltage from the converter 102 to the linear regulator 112. The linear regulator 112 regulates the signal and generates a smooth output at a substantially constant 2 volts, as required in the example. There is very little loss encountered in this linear regulation in the interface 107 because it is only dropping about 100 millivolts from the signal on average. This is compared with dropping the supply from the battery with a linear regulator which would have very high losses as the battery voltage may be as high as 4.2 volts.

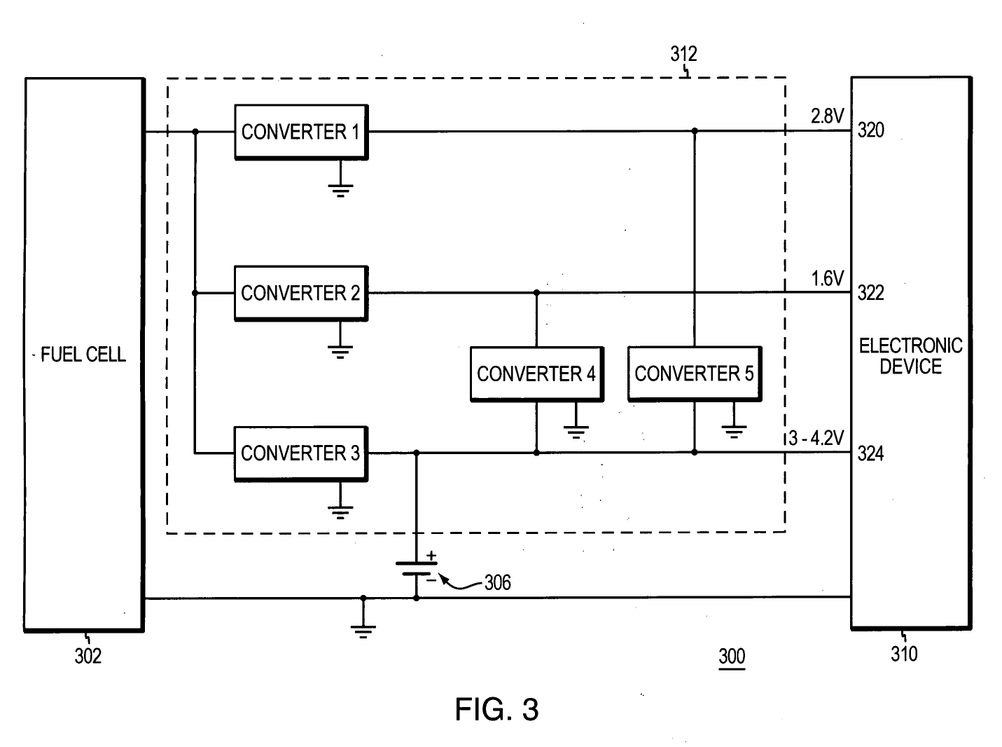

FIG. 3 illustrates one embodiment of a system for implementing features of the invention described in the block diagrams of FIGS. 1 and 2. The system 300 includes a fuel cell 302 which is governed by a system controller (not shown). The fuel cell 302 and a suitable battery 306 provide power to an electronic device 310 by way of the interface, which is illustrated in dashed box 312. The fuel cell output in the embodiment of FIG. 3 can be applied to one of the DC-DC converters of the interface 312. For example, converter 1 supplies a 2.8 voltage rail to input 320 of the electronic device 310. Converter 2 provides a 1.6 voltage rail to input 322 of the electronic device 310. Converter 3 charges the battery at 3-4.2 v, via the input 324 of electronic device 310. It should be understood by those skilled in the art that the specific voltages are for illustrative purposes only and are not limiting to the scope of the invention.

The battery 306 supplies supplemental power to the electronic device 310 by way of converters 4 and 5 when the power output available from converters 1 and 2 is insufficient to meet load demands. Converters 4 and 5 may be part of the electronic device and could be linear or switching voltage regulators. Thus, as is apparent from the block diagram of FIG. 3, converters 4 and 5 are tied to the battery rail for their respective inputs, and their outputs are coupled to the electronic device at inputs 322 and 320, respectively.

As noted, converter 3 is also configured to supply charge to the battery if the battery requires additional charging. It is noted that there may be circumstances in which it is deemed to be more efficient to supply power from the battery directly to the electronic device such as at peak power requirement conditions than from the fuel cell and interface. Startup conditions also require the battery to supply the power while the fuel cell is starting up.

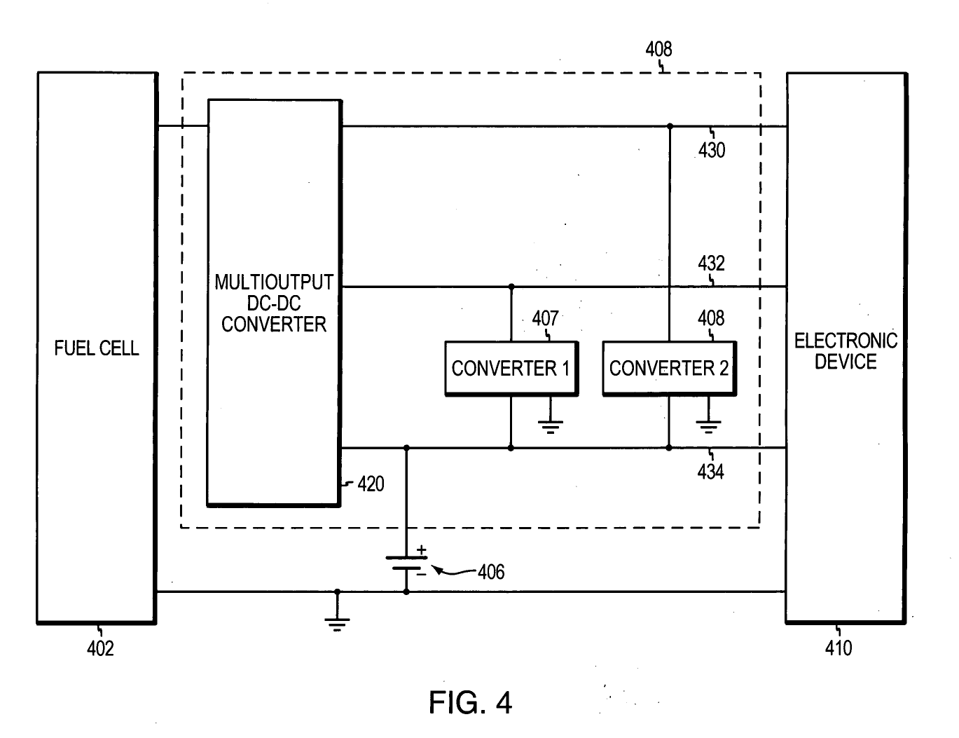

FIG. 4 illustrates a system 400 in which the interface includes a single DC-DC converter with multiple output voltages that is employed to supply power. The system 400 includes a fuel cell 402. The fuel cell 402 is coupled to an interface 408. The interface 408 includes a multi-output DC-DC converter 420 that is coupled to receive the fuel cell output. The multi-output DC-DC converter 420 can be used to boost or buck the fuel cell output voltage directly to the voltage required by the electronic device 410, More specifically, the output voltage of the DC-DC converter 420 is switched among the different voltage rails, 430, 432, and 434 as required to maintain the desired voltages and charge the battery if there is excess fuel cell power. If the fuel-cell power is not adequate to service the loads then the battery will supply power to the device rails through converters 407 and 408. Converters 407 and 408 may be part of the device and could be linear or switching voltage regulators. In this embodiment, part count is reduced because one DC-DC converter with a single inductor and some extra switches is used to both directly supply the electronic device at a voltage different than the battery voltage, or to recharge the battery in the conventional manner.

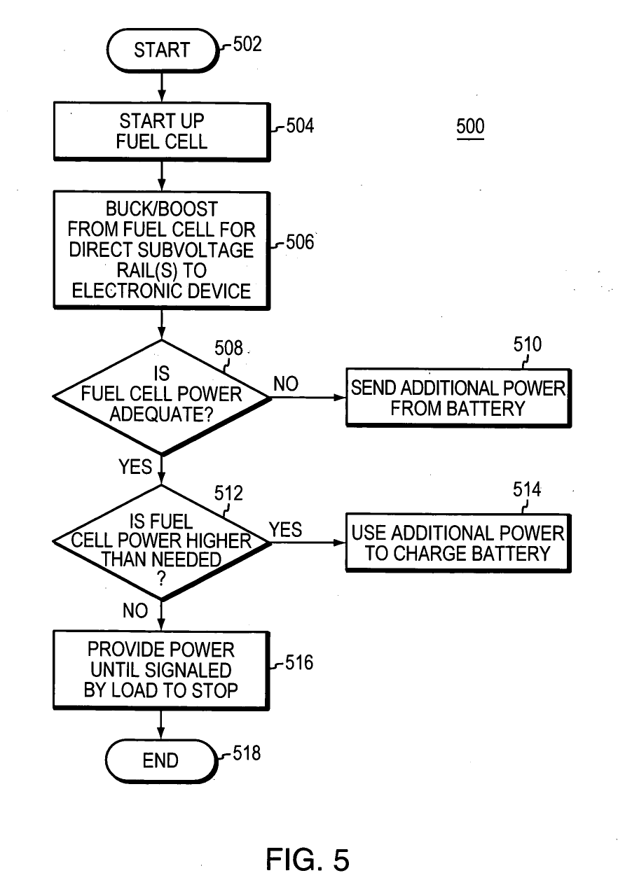

The method of the present invention can be understood with reference to the flow chart 500 of FIG. 5. The procedure begins at the start step 502 and proceeds to step 504 at which time the fuel cell is started up. At step 506, an interface that includes one or more DC-DC converters (as in FIGS. 3 and 4) is used to convert power from the fuel cell directly to the voltage rails required by the electronic device. In decision step 508, it is determined whether the fuel cell power is adequate to supply the electronic device. If it is not adequate, then the procedure continues to step 510 in which additional power is supplied by the battery. If, instead the fuel cell power is adequate for the electronic device, the procedure continues to step 512 in which it is determined whether the fuel cell power is higher than that required. If the fuel cell output power is higher than that required, then the procedure continues to step 514 and the additional power is used to charge the battery. If the fuel cell power is not higher than that required, then the procedure continues to step 516 in which power is provided as needed by the electronic device until the system controller signals the fuel cell or the DC-DC converter to discontinue power. At that point, a different one of the DC-DC converters may begin to provide power for different voltage rails or the battery may be charged or the power pack will perform the functions as directed by the system controller. The procedure ends at step 518 when the electronic device is powered down.

It should be understood that the invention provides a system and method for providing multiple voltages inputs to an electronic device in a powerpack that is a hybrid fuel cell/battery powerpack. This increases the overall efficiency of the powerpack. In addition, the interface that has the multiple output converter has fewer parts than the interface that includes multiple converters, thus providing a lower- part embodiment of the invention for particular applications of the invention in which it is deemed appropriate or desirable.

The foregoing description has been directed to particular embodiments of this invention. It will be apparent however, that other variations and modifications may be made to the described embodiments, with the attainment of some or all of their advantages. Further, the functions of the converters and other components may be distributed among any number of separate systems, wherein each system performs one or more of the functions. Additionally, the procedures described herein may be implemented in hardware, software, embodied as a computer-readable medium having program instructions, firmware, or a combination thereof. Therefore, it is the object of the appended claims to cover all such variations and modifications as come within the true spirit and scope of the invention.

1. A power supply for an electronic device comprising:
a. a direct oxidation fuel cell;
b. one or more rechargeable batteries coupled to supply power to the electronic application device;
c. an interface coupled between said fuel cell, said one or more batteries, and said electronic device, said interface including one or more DC-DC converters coupled to receive the output of the fuel cell, and to supply power to said one or more batteries, and further being coupled to said electronic device such that said fuel cell and DC-DC converter(s) provide one or more voltages at required voltage rail(s) directly to said electronic device.

2. The power supply as defined in claim 1 wherein said interface is adapted to provide multiple levels of electric output voltage to be alternatively drawn by said electronic device as needed.

3. The power supply as defined in claim 1 wherein said battery supplies additional power to the electronic device when a total output capacity of said fuel cell and interface is less than that demanded by said electronic device.

4. The power supply as defined in claim 3 wherein said fuel cell and interface supplies a maximum amount of output capacity to said electronic device, while said battery supplies a remaining requirement.

5. The power supply in claim 1 wherein power from said fuel cell is in excess of that required by the device and the extra power is used to charge said battery or batteries.

6. The power supply as defined in claim 3 wherein said output power supplied by said fuel cell and interface, and said output power supplied by said battery are apportioned in any manner as desired in a particular application.

7. The power supply as defined in claim 1 further comprising a secondary conversion device coupled to receive the output of said interface and said interface is adapted to produce an intermediate voltage to said secondary conversion device, which then supplies the power to the electronic device to achieve additional output voltage and current conditioning.

8. The power supply as defined in claim 1 wherein said fuel cell and interface are adapted to maintain a precharge on an output side of an auxiliary converter coupled to said battery.

9. An interface for a power pack for an electronic device, said power pack including a fuel cell and a battery, the interface comprising:
a plurality of DC-DC converters, each converter coupled to receive an output voltage of said fuel cell and to convert said output voltage of the fuel cell to one or more desired voltages for the electronic device, and said plurality of DC-DC converters being coupled to said electronic device to thereby provide multiple input voltage rails for said electronic device.

10. The interface as defined in claim 9 wherein one DC-DC converter of said plurality of DC-DC converters is also coupled to supply power to said battery.

11. The interface as defined in claim 10 wherein said battery supplies supplemental power to the electronic device when a total output capacity of said fuel cell is less than that demanded by said electronic device.

12. The interface as defined in claim 10 wherein said output power supplied by said fuel cell through said DC-DC converters, and said output power supplied by said battery are apportioned in any manner as desired in a particular application.

13. The interface as defined in claim 11 further comprising at least one DC-DC converter coupled with the battery as an input and further coupled to an input of the electronic device to provide said supplemental power from said battery as required by said electronic device.

14. An interface for a power pack for an electronic device, said power pack including a fuel cell and a battery, the interface comprising:
a DC-DC converter coupled to receive an output voltage of said fuel cell and to convert said output voltage of the fuel cell to a desired voltage for the battery, and said DC-DC converter having two or more output switches that can couple its out put to a voltage rail of said electronic device or to the battery to thereby provide power to a voltage rail of said electronic device or to charge the battery.

15. A method of providing power to an electronic device, comprising the steps of:
providing a fuel cell and an interface including one or more DC-DC converters coupled to the electronic device and a battery;
configuring the interface to provide multiple voltages as needed by said electronic device; and
supplying a particular voltage directly from said interface to said electronic device.

16. The method as defined in claim 15 comprising the further step of:
supplying directly from said fuel cell and interface to said electronic device a maximum amount of output capacity, while said battery supplies a remaining requirement.

17. The method as defined in claim 15 comprising the further step of:
supplying directly from said fuel cell and interface to said electronic device the power said electronic device requires, while using remaining power to charge said battery.

18. The method as defined in claim 15 comprising the further step of:
coupling a DC-DC converter to receive an output voltage of said fuel cell and to convert said output voltage of the fuel cell to multiple output voltage rails that can supply said battery different voltage rails of said electronic device.

19. The method as defined in claim 15 comprising the further step of:
coupling an input of one or more DC-DC converter to said battery to produce a desired voltage for providing supplemental power needed by said electronic device.

20. The method as defined in claim 15 including the further step of:
boosting an output of the fuel cell to an amount that is slightly higher than required; and
regulating the output of said interface to provide a conditioned voltage to said electronic device.
